(19) United States
(12) Patent Application Publication
(10) Pub. No.: US 2022/0053756 A1
(43) Pub. Date: Feb. 24, 2022

(54) CHIP CARRIER FOR SINGLE SPERM OR EXTREMELY SMALL AMOUNT OF SPERMS

(71) Applicant: Changzhou Maternal And Child Health Care Hospital, Changzhou City, Jiangsu (CN)

(72) Inventors: Zhilei MAO, Changzhou City, Jiangsu (CN); Yurui CHE, Changzhou City, Jiangsu (CN); Keliang ZHANG, Changzhou City, Jiangsu (CN); Jun ZHOU, Changzhou City, Jiangsu (CN); Li CHEN, Changzhou City, Jiangsu (CN); Zhiqiang QIN, Changzhou City, Jiangsu (CN); Lina ZHANG, Changzhou City, Jiangsu (CN)

(21) Appl. No.: 17/312,399

(22) PCT Filed: Aug. 1, 2019
(86) PCT No.: PCT/CN2020/106286

§ 371 Date: Jun. 10, 2021

(30) Foreign Application Priority Data
Jan. 8, 2019 (CN) 201910708554.X

(51) Int. Cl. A01N 1/02

(52) U.S. Cl. CPC A01N 1/0268

(57) ABSTRACT

The invention discloses a chip carrier for single sperm or extremely small amount of sperms, comprising a chip carrier, an X indicator axis, a Y indicator axis, and microarrays; the chip carrier is composed of a coating layer, a polymeric material layer and specific antibodies adsorbed on the coating layer; the polymeric material layer is located at the bottom of the chip carrier; the upper surface of the polymeric material layer is attached to the lower surface of the coating layer; the coating layer is provided with several microarrays. Single sperm or extremely small amount of sperms can be stored which realizes the effective storage of single sperm or extremely small amount of sperms, to avoid cross-contamination; in addition, precise access to sperm can be realized, and the maneuverability is very strong, which can solve the requirement of cryopreservation of sperm in patients with very few sperms.

### BACKGROUND OF THE INVENTION

### 1. Field of the Invention

The invention belongs to the technical field of chip carriers, in particular to a chip carrier for single sperm or extremely small amount of sperms.

### 2. Description of the Related Art

At present, among infertile families in the world, about 40%-50% are caused by male causes. Among them, azoospermia affects 1% of the world's male population and is a major problem for human survival and reproduction. According to research data from an international research group, from 1973 to 2011, male sperm counts in North America, Australia, New Zealand and some European countries fell by 52%, from about 99 million sperm per milliliter to 47 million sperm per milliliter. The number of sperm in men in developing countries is also declining, at a slower rate than in developed countries. This report has aroused worldwide attention, so the preservation of male fertility will become a major public health problem in the near future. Male infertility can be divided into primary infertility and secondary infertility. Studies have shown that genetic factors are important influencing factors. Polymorphisms of methionine synthase reductase genes, CLOCK genes, mutations or gene deletions of genes such as SOHLH1 are all causes of primary male infertility. Secondary male infertility is mostly caused by environmental pollution, bad living habits, harmful exposure, etc. As environmental pollution, age and life pressure continue to increase, more and more men suffer from abnormal sperm quality and infertility. People's demand for childbearing is becoming more and more urgent. All in all, the incidence of male infertility is gradually increasing, and it has gradually attracted human attention. Fertility preservation has become an urgent clinical need. For patients with oligospermia, a small amount of high-quality sperm obtained through manual screening is very precious, while for patients with azoospermia, a very small amount of sperm obtained through puncture or surgery is their hope for reproduction, so the preservation of these sperm is particularly important. Therefore, due to the environment, living habits or unexplained reasons, there are few sperm or poor sperm quality. There are many such patients in clinic who have fertility needs, and there is an urgent need for effective methods for cryopreserving very few sperm.

At present, due to the environment, living habits or unknown reasons, there are few sperm or poor sperm quality. There are many such patients who have the need for fertility in clinic, and there is an urgent need for effective methods for cryopreserving very few sperm.

### SUMMARY OF THE INVENTION

The purpose of the invention is to provide a storage method and chip carrier for single sperm or extremely small amount of sperms in order to solve the above problems.

In order to solve the above problems, the invention provides a technical solution:

a chip carrier for single sperm or extremely small amount of sperms, comprising a chip carrier, an X indicator axis, a Y indicator axis, and microarrays, wherein the chip carrier is composed of a coating layer and a polymeric material layer; the polymeric material layer is located at the bottom of the chip carrier; the upper surface of the polymeric material layer is attached to the lower surface of the coating layer; the coating layer is provided with several microarrays.

Preferably, the adjacent two sides of the coating layer are respectively provided with an X indicator axis and a Y indicator axis; the Y indicator axis is provided with capital letters with the same number of columns as the microarray and arranged in order; the polymeric material layer is provided with lowercase letters with the same number of rows as the microarray and arranged in order.

Preferably, the microarrays are microarrays in the form of specific antibodies.

Preferably, the coating layer is one or more of polylysine, protamine, and avidin biotin system.

Preferably, the number of arrays of the microarrays is determined by the area of the polymeric material layer and the coating layer; the distance between two adjacent grooves in the microarray is less than 50 nm; or the microarrays are randomly distributed on the coating layer.

Preferably, gray marking lines are provided between two adjacent grooves in the microarray.

Preferably, the size of the chip carrier is less than or equal to 1 mm*1 mm, and a corner of the chip carrier is provided with a pulling wire.

Preferably, the polymeric material in the polymeric material layer is selected from one or several mixtures of polystyrene, nitrocellulose, polyvinyl chloride, and polyethylene.

Preferably, the specific antibodies on the microarrays are fixed on the polymeric material layer through the adsorption of the coating layer.

A storage method for single sperm or extremely small amount of sperms, specifically divided into the following steps:

A. processing; placing the sperms to be stored in a glycerol test tube in batches and shaking;

B. observing; putting the mixed sperm and glycerin into an observation dish for observation;

C. clamping; placing the observation dish under the microscope, and using a dropper to suck a small amount of sperms;

D. placing; arranging the sperms orderly on the microarray on the chip carrier;

E. refrigerating; putting the chip carrier filled with sperms in a liquid nitrogen freezer, and keeping it at −160° C. to −220° C.

The advantageous effects of the invention:

In the invention, single sperm or extremely small amount of sperms can be stored by placing the single sperm picked under the microscope on the microarray on the chip carrier, and then placing the chip in the cryotube for conventional freezing, which realizes the effective storage of single sperm or extremely small amount of sperms, to avoid cross-contamination; in addition, precise access to sperm can be realized, and the maneuverability is very strong, which can solve the requirement of cryopreservation of sperm in patients with very few sperms.

### BRIEF DESCRIPTION OF THE PREFERRED EMBODIMENTS

For ease of description, the invention will be described in detail hereinafter by the following specific implementation and drawings.

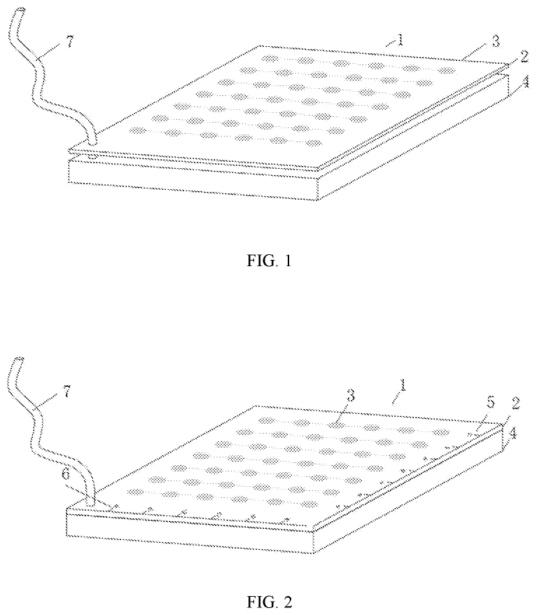

FIG. 1 is a schematic diagram of the structure of the invention;

FIG. 2 is a schematic diagram of the X indicator axis and the Y indicator axis of the invention.

In the figures, 1 refers to the chip carrier; 2 refers to the coating layer; 3 refers to the microarray; 4 refers to the polymeric material layer; 5 refers to the X indicator axis; 6 refers to the Y indicator axis; 7 refers to the pulling wire.

### DETAILED DESCRIPTION OF THE PREFERRED EMBODIMENTS

As shown in FIG. 1-2, the embodiment adopts the following technical solutions: a chip carrier for single sperm or extremely small amount of sperms, comprising a chip carrier 1, an X indicator axis 5, a Y indicator axis 6, and microarrays 3, wherein the chip carrier 1 is composed of a coating layer 2 and a polymeric material layer 4; the polymeric material layer 4 is located at the bottom of the chip carrier 1; the upper surface of the polymeric material layer 4 is attached to the lower surface of the coating layer 2; the coating layer 2 is provided with several microarrays 3.

The adjacent two sides of the coating layer 2 are respectively provided with an X indicator axis 5 and a Y indicator axis 6; the Y indicator axis 6 is provided with capital letters with the same number of columns as the microarray 3 and arranged in order; the polymeric material layer 4 is provided with lowercase letters with the same number of rows as the microarray 3 and arranged in order; the serial number of each individual sperm is recorded by means of coordinates.

The microarrays 3 are microarrays 3 in the form of specific antibodies, and the sperm head is fixed on the microarray 3 for precise recognition.

The coating layer 2 is one or more of polylysine, protamine, and avidin biotin system, which is convenient to fix the specific antibodies of the microarray 3 on the polymeric material, and then use the antibodies to adsorb sperms.

The number of arrays of the microarrays 3 is determined by the area of the polymeric material layer 4 and the coating layer 2; the distance between two adjacent grooves in the microarray 3 is less than 50 nm, or randomly distributed on the coating layer 2.

Gray marking lines are provided between two adjacent grooves in the microarray 3 to facilitate the observation and identification of coordinates.

The size of the chip carrier 1 is less than or equal to 1 mm*1 mm, and a corner of the chip carrier 1 is provided with a pulling wire 7 to facilitate the removal of the chip carrier 1.

The polymeric material in the polymeric material layer 4 is selected from one or several mixtures of polystyrene, nitrocellulose, polyvinyl chloride, and polyethylene.

The specific antibodies on the microarrays 3 are fixed on the polymeric material layer 4 through the adsorption of the coating layer 2.

A storage method for single sperm or extremely small amount of sperms, specifically divided into the following steps:

A. processing; placing the sperms to be stored in a glycerol test tube in batches and shaking;

B. observing; putting the mixed sperm and glycerin into an observation dish for observation;

C. clamping; placing the observation dish under the microscope, and using a dropper to suck a small amount of sperms;

D. placing; arranging the sperms orderly on the microarray (3) on the chip carrier (1);

E. refrigerating; putting the chip carrier (1) filled with sperms in a liquid nitrogen freezer, and keeping it at −160° C. to −220° C.

Specifically: when in use, put the single sperm picked under the microscope on the microarray 3 on the chip carrier 1, and then put the chip into the cryotube for conventional freezing to complete the storage of single sperm or extremely small amount of sperms.

The adjacent two sides of the coating layer 2 are respectively provided with an X indicator axis 5 and a Y indicator axis 6; the Y indicator axis 6 is provided with capital letters with the same number of columns as the microarray 3 and arranged in order; the polymeric material layer 4 is provided with lowercase letters with the same number of rows as the microarray 3 and arranged in order; the serial number of each individual sperm is recorded by means of coordinates; the microarrays 3 are microarrays 3 in the form of specific antibodies, and the sperm head is fixed on the microarray 3 for precise recognition; the coating layer 2 is one or more of polylysine, protamine, and avidin biotin system, which is convenient to fix the specific antibodies of the microarray 3 on the polymeric material, and then use the antibodies to adsorb sperms; the number of arrays of the microarrays 3 is determined by the area of the polymeric material layer 4 and the coating layer 2; the distance between two adjacent grooves in the microarray 3 is less than 50 nm, or randomly distributed on the coating layer 2; gray marking lines are provided between two adjacent grooves in the microarray 3 to facilitate the observation and identification of coordinates.

The above shows and describes the basic principles and main features of the invention and the advantages of the invention. Those skilled in the art should understand that the invention is not limited by the above embodiments. The above embodiments and the description in the specification only illustrate the principles of the invention. Various modifications and improvements may be made without departing from the spirit and scope of the invention, which shall all fall within the scope of the claimed invention. The scope of protection claimed by the invention is defined by the appended claims and the equivalents thereof.

1. A chip carrier for single sperm or extremely small amount of sperms, comprising a chip carrier (1), an X indicator axis (5), a Y indicator axis (6), and microarrays (3), wherein the chip carrier (1) is composed of a coating layer (2) and a polymeric material layer (4); the polymeric material layer (4) is located at the bottom of the chip carrier (1); the upper surface of the polymeric material layer (4) is attached to the lower surface of the coating layer (2); the coating layer (2) is provided with several microarrays (3).

2. The chip carrier for single sperm or extremely small amount of sperms according to claim 1, wherein the adjacent two sides of the coating layer (2) are respectively provided with an X indicator axis (5) and a Y indicator axis (6); the Y indicator axis (6) is provided with capital letters with the same number of columns as the microarray (3) and arranged in order; the polymeric material layer (4) is provided with lowercase letters with the same number of rows as the microarray (3) and arranged in order.

3. The chip carrier for single sperm or extremely small amount of sperms according to claim 1, wherein the microarrays (3) are microarrays (3) in the form of specific antibodies.

4. The chip carrier for single sperm or extremely small amount of sperms according to claim 1, wherein the coating layer (2) is one or more of polylysine, protamine, and avidin biotin system.

5. The chip carrier for single sperm or extremely small amount of sperms according to claim 1, wherein the number of arrays of the microarrays (3) is determined by the area of the polymeric material layer (4) and the coating layer (2); the distance between two adjacent grooves in the microarray (3) is less than 50 nm.

6. The chip carrier for single sperm or extremely small amount of sperms according to claim 1, wherein gray marking lines are provided between two adjacent grooves in the microarray (3).

7. The chip carrier for single sperm or extremely small amount of sperms according to claim 1, wherein the size of the chip carrier (1) is less than or equal to 1 mm*1 mm, and a corner of the chip carrier (1) is provided with a pulling wire (7).

8. The chip carrier for single sperm or extremely small amount of sperms according to claim 1, wherein the polymeric material in the polymeric material layer (4) is selected from one or several mixtures of polystyrene, nitrocellulose, polyvinyl chloride, and polyethylene.

9. The chip carrier for single sperm or extremely small amount of sperms according to claim 1, wherein the specific antibodies on the microarrays (3) are fixed on the polymeric material layer (4) through the adsorption of the coating layer (2).

10. A storage method for single sperm or extremely small amount of sperms, specifically divided into the following steps:
A. processing; placing the sperms to be stored in a glycerol test tube in batches and shaking;
B. observing; putting the mixed sperm and glycerin into an observation dish for observation;
C. clamping; placing the observation dish under the microscope, and using a dropper to suck a small amount of sperms;
D. placing; arranging the sperms orderly on the microarray (3) on the chip carrier (1);
E. refrigerating; putting the chip carrier (1) filled with sperms in a liquid nitrogen freezer, and keeping it at −160° C. to −220° C.
